(19) United States
(12) Patent Application Publication
(10) Pub. No.: US 2025/0028132 A1
(43) Pub. Date: Jan. 23, 2025

(54) CLOSURE AND ORGANIZER ASSEMBILES THEREFOR

(71) Applicant: AFL Telecommunications LLC, Duncan, SC (US)

(72) Inventors: Wilfred Courchaine, Moore, SC (US); Ted Lichoulas, Simpsonville, SC (US); Scott Charles, Hickory, NC (US)

(21) Appl. No.: 18/711,263

(22) PCT Filed: Nov. 18, 2022
(86) PCT No.: PCT/US2022/050358

§ 371 Date: May 17, 2024

Related U.S. Application Data
(60) Provisional application No. 63/329,642, filed on Apr. 11, 2022.
(60) Provisional application No. 63/281,589, filed on Nov. 19, 2021.

(51) Int. Cl. G02B 6/44; G02B 6/38

(52) U.S. Cl. CPC G02B 6/4442; G02B 6/3825; G02B 6/3897; G02B 6/44528; G02B 6/4455

(57) ABSTRACT

A fiber optic closure is provided including an organizer tray and a mount platform. The organizer tray includes a tray main body including a base wall including a plurality of module mounting locations including a plurality of leg slots and one or more positioning slots defined through the base wall. The mount platform includes a platform base and a platform leg extending from the platform base. The platform base forms a wall configured substantially flush to the base wall. The platform leg is insertable into corresponding leg slots at the mount location. The mount platform includes a retainer wall extending along the transverse axis from an upper surface of the platform base. The retainer wall extends along a first direction to form a detent for a telecommunications module mountable to the organizer tray. The detent is along a second direction perpendicular to the first direction.

### PRIORITY STATEMENT

The present application claims the benefit of priority to U.S. Provisional Patent Application Ser. No. 63/281,589, filed on Nov. 19, 2021, and U.S. Provisional Patent Application Ser. No. 63/329,642, filed on Apr. 11, 2022, the disclosures of which are incorporated by reference herein in their entirety.

### FIELD

The present disclosure relates generally to closures, such as for fiber optic cable connections.

### BACKGROUND

Certain closures, also referred to as “butt” or “domed” closures, are utilized in outdoor environments to facilitate the connection of transmission cables such as fiber optic cables. The cables enter the closure through a sealed base, and connection of the cable elements occurs within the closure. In the case of fiber optic cables, spliced-together optical fibers are held within the closure.

Users, such as telecommunications technicians and engineers, are challenged to increase the density of fiber optic connections and routing elements into a single closure. Organizer assemblies may receive increasingly greater connections and telecommunications modules. However, as connection quantities increase, cables and routing elements may generally increase, which may inhibit further increase, maintenance, and workability of connections and routing elements within the organizer assembly.

Accordingly, improved organizer assemblies for use with butt closures would be advantageous. Specifically, organizer assemblies which address one of more of the above-stated deficiencies would be advantageous.

### BRIEF DESCRIPTION

Aspects and advantages of the invention will be set forth in part in the following description, or may be understood from the description, or may be learned through practice of the invention.

An aspect of the present disclosure is directed to a fiber optic closure including a cover, an organizer assembly, a bracket assembly, an organizer tray, and a mount platform. The cover forms a closure interior and an opening providing access to the closure interior. The organizer assembly is insertable into the closure interior. The organizer assembly includes the bracket assembly extending along a transverse axis. The bracket assembly includes a main body and a plurality of hinge assemblies. The plurality of hinge assemblies is spaced apart in a linear array along the transverse axis. The organizer tray is rotatably connectable and removable to a respective one of the plurality of hinge assemblies at the bracket assembly. The organizer tray includes a tray main body including a base wall, a first sidewall, a second sidewall, and a front wall, and a rear end forming an open end and the front wall forming a closed end. The base wall includes a plurality of module mounting locations including a plurality of leg slots and one or more positioning slots defined through the base wall. The plurality of leg slots form at least a portion of a periphery of the module mounting location. The mount platform includes a platform base and a platform leg extending from the platform base. The platform base forms a wall configured substantially flush to the base wall. The platform leg is insertable into corresponding leg slots at the mount location. The mount platform includes a retainer wall extending along the transverse axis from an upper surface of the platform base. The retainer wall extends along a first direction to form a detent for a telecommunications module mountable to the organizer tray. The detent is along a second direction perpendicular to the first direction.

Another aspect of the present disclosure is directed to a fiber optic closure including a cover, an organizer assembly, a bracket assembly, an organizer tray, and an adapter mount. The cover forms a closure interior and an opening providing access to the closure interior. The organizer assembly is insertable into the closure interior. The organizer assembly includes the bracket assembly extending along a transverse axis. The bracket assembly includes a main body and a plurality of hinge assemblies. The plurality of hinge assemblies is spaced apart in a linear array along the transverse axis. The organizer tray is rotatably connectable and removable to a respective one of the plurality of hinge assemblies at the bracket assembly. The organizer tray includes a tray main body including a base wall, a first sidewall, a second sidewall, and a front wall, and a rear end forming an open end and the front wall forming a closed end. The base wall includes a plurality of module mounting locations including a plurality of leg slots and one or more positioning slots defined through the base wall. The plurality of leg slots form at least a portion of a periphery of the module mounting location. The adapter mount includes a mount base and a mount leg extending from the mount base. The mount base forms a wall configured substantially flush to the base wall. The mount leg is insertable into corresponding leg slots at the mount location. The adapter mount includes a mount wall forming one or more adapter openings configured to receive a telecommunications adapter.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF FIGURES

A full and enabling disclosure of the present invention, including the best mode thereof, directed to one of ordinary skill in the art, is set forth in the specification, which makes reference to the appended figures, in which:

FIG. 1 is a perspective view of a closure in accordance with embodiments of the present disclosure;

FIG. 2 is a perspective view of an organizer assembly in accordance with embodiments of the present disclosure;

FIG. 3 is a perspective view of an organizer assembly in accordance with embodiments of the present disclosure;

FIG. 4 is a perspective view of an organizer tray including a mount platform in accordance with embodiments of the present disclosure;

FIG. 5A is a perspective view of a mount platform in accordance with embodiments of the present disclosure;

FIG. 5B is a perspective view of the mount platform of FIG. 5A in accordance with embodiments of the present disclosure;

FIG. 5C is a perspective view of the mount platform of FIG. 5B in accordance with embodiments of the present disclosure;

FIG. 6 is a perspective view of the organizer tray including a telecommunications module and mount platform in accordance with embodiments of the present disclosure;

FIG. 7 is a perspective view of the organizer tray including a telecommunications module and mount platform in accordance with embodiments of the present disclosure;

FIG. 8 is a perspective view of the organizer tray including a telecommunications module and mount platform in accordance with embodiments of the present disclosure;

FIG. 9A is a perspective view of a mount platform in accordance with embodiments of the present disclosure;

FIG. 9B is a perspective view of the mount platform of FIG. 9A in accordance with embodiments of the present disclosure;

FIG. 10 is a perspective view of a mount platform in accordance with embodiments of the present disclosure;

FIG. 11A is a top-down view of an organizer tray including a mount platform in accordance with embodiments of the present disclosure;

FIG. 11B is a top-down view of an organizer tray including a mount platform in accordance with embodiments of the present disclosure;

FIG. 11C is a top-down view of an organizer tray including a mount platform in accordance with embodiments of the present disclosure;

FIG. 12A is a perspective view of a mount platform in accordance with embodiments of the present disclosure;

FIG. 12B is a perspective view of the mount platform of FIG. 12A in accordance with embodiments of the present disclosure;

FIG. 12C is a perspective view of a mount platform in accordance with embodiments of the present disclosure;

FIG. 12D is a perspective view of the mount platform of FIG. 12C in accordance with embodiments of the present disclosure;

FIG. 13A is a top-down view of an organizer tray including the mount platform of FIGS. 12A-12D in accordance with embodiments of the present disclosure;

FIG. 13B is a top-down view of an organizer tray including the mount platform in accordance with embodiments of the present disclosure;

FIG. 13C is a top-down view of an organizer tray including the mount platform of FIGS. 12A-12D in accordance with embodiments of the present disclosure;

FIG. 14 is a perspective view of the organizer tray including a telecommunications module in a mount platform and a telecommunications adapter in an adapter mount in accordance with embodiments of the present disclosure;

FIG. 15A is a perspective view of an adapter mount in accordance with embodiments of the present disclosure;

FIG. 15B is a top-down view of the adapter mount of FIG. 15A in accordance with embodiments of the present disclosure;

FIG. 15C is a perspective view of an adapter mount in accordance with embodiments of the present disclosure;

FIG. 15D is a top-down view of the adapter mount of FIG. 15C in accordance with embodiments of the present disclosure;

FIG. 16A is a perspective view of an adapter mount in accordance with embodiments of the present disclosure;

FIG. 16B is a top-down view of the adapter mount of FIG. 16A in accordance with embodiments of the present disclosure;

FIG. 17A is a perspective view of an adapter mount in accordance with embodiments of the present disclosure;

FIG. 17B is a perspective view of the adapter mount of FIG. 17A, including a telecommunications adapter, in accordance with embodiments of the present disclosure;

FIG. 17C is a perspective view of the adapter mount of FIG. 17B, including the telecommunications adapter, in accordance with embodiments of the present disclosure;

FIG. 18A is an exploded view of an adapter mount in accordance with embodiments of the present disclosure;

FIG. 18B is a perspective view of the adapter mount in accordance with embodiments of the present disclosure;

FIG. 18C is a perspective view of the adapter mount of FIG. 18B, including a telecommunications adapter, in accordance with embodiments of the present disclosure;

FIG. 18D is a bottom-up perspective view of the adapter mount of FIG. 18C in accordance with embodiments of the present disclosure;

FIG. 19A is a perspective view of an adapter mount in accordance with aspects of the present disclosure;

FIG. 19B is a perspective view of a portion of the adapter mount of FIG. 19A, including a telecommunications adapter, in accordance with embodiments of the present disclosure;

FIG. 19C is a perspective view of the adapter mount of FIG. 19A, including the telecommunications adapter, in accordance with embodiments of the present disclosure;

FIG. 20A is a perspective view of an adapter mount, including a telecommunications adapter, in accordance with embodiments of the present disclosure;

FIG. 20B is a perspective view of a portion of an adapter mount in accordance with embodiments of the present disclosure;

FIG. 20C is a perspective view of a portion of the adapter mount of FIG. 20A in accordance with embodiments of the present disclosure;

FIG. 20D is a perspective view of the portion of the adapter mount of FIG. 20C in accordance with embodiments of the present disclosure; and

FIG. 21 is a top-down view of an organizer tray including an adapter mount in accordance with aspects of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Embodiments of a telecommunications closure, organizer assembly, and mount structures at the organizer assembly are provided. Embodiments provided herein, separately or collectively, may allow users, such as telecommunications technicians and engineers, to increase the density of fiber optic connections and routing elements into a single closure, while permitting maintainability and workability of connections and routing elements within the organizer assembly. For instance, mount platforms and adapter mounts provided herein allow users to affix various desired combinations of telecommunications modules and telecommunications adapters or bulkheads to the organizer assembly. Further embodiments allow for various desired orientations of the modules and telecommunications adapters, such as to route or desirably bias cables and telecommunications elements toward from an entrance and/or to an exit of the organizer assembly or closure. Embodiments provided herein may allow users to more densely pack modules, adapters, connectors, and telecommunications elements at each organizer assembly and closure, and may further allow for such while maintaining or improving workability (e.g., routing, splicing, etc.) of various telecommunications elements.

Referring now to the figures, embodiments of closures 10 and organizer assemblies in accordance with the present disclosure are provided. Closures 10 in accordance with the present disclosure, and in particular the organizer assemblies and tray organizer assemblies, thereof, may advantageously provide improved routing features which reduce kinking and attenuation risks. Certain embodiments of closure 10 may form a butt closure or domed closure for fiber optic cable connections. Receptacles, such as closures 10, organizer baskets 110 or trays 200 thereof in accordance with the present disclosure may advantageously provide improved features for securing and positioning cables 42 at and through organizer trays and baskets in a variety of positions. Mount structures, such as mount platforms and adapter mounts provided herein, may advantageously allow efficient and effective fiber-populating, fiber splicing, improve cable routing consistency, allow for installation, implementation, and access of a variety of tray geometries to fit and rotate at the closure, or position the rotatable receptacles away such as to reduce kinking, binding, or interference of cables extending into and out of the receptacle.

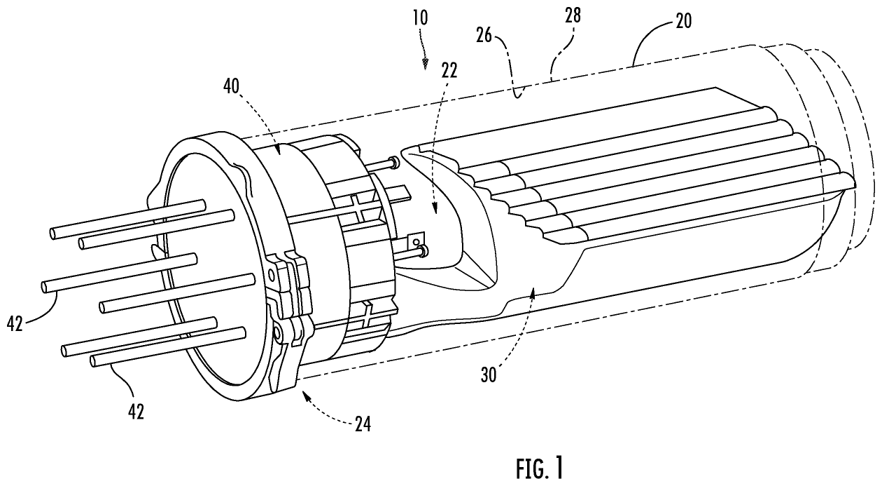

Referring now to FIG. 1, a closure 10 in accordance with the present disclosure includes a cover 20. Cover 20 is generally a domed cover which defines an interior 22 and an opening 24 which provides access to the interior 22. Cover 20 may include an inner surface 26 which defines the interior 22 and an opposing outer surface 28 which is exposed to the external environment.

An organizer assembly 30 may be insertable into (and thus disposed within) the interior 22, such as along a longitudinal axis of the closure 10. Organizer assembly 30 may include one or more organizer trays 200 and/or other suitable components for facilitating transmission component connections. For example, in the case of use with fiber optic cables, splices between optical fibers thereof may be housed in the various splice trays.

A base 40 may be insertable at least partially into (and thus disposed at least partially within) the interior 22. In some embodiments, organizer assembly 30 may be connected to the base 40, such that insertion of the base 40 causes insertion of the tray assembly 30 into the interior 22. Cables 42 may be inserted through the base 40 into the interior 22, and connection between transmission elements thereof (such as optical fibers) may be made within the interior 22, such as in the organizer trays 200 of the organizer assembly 30.

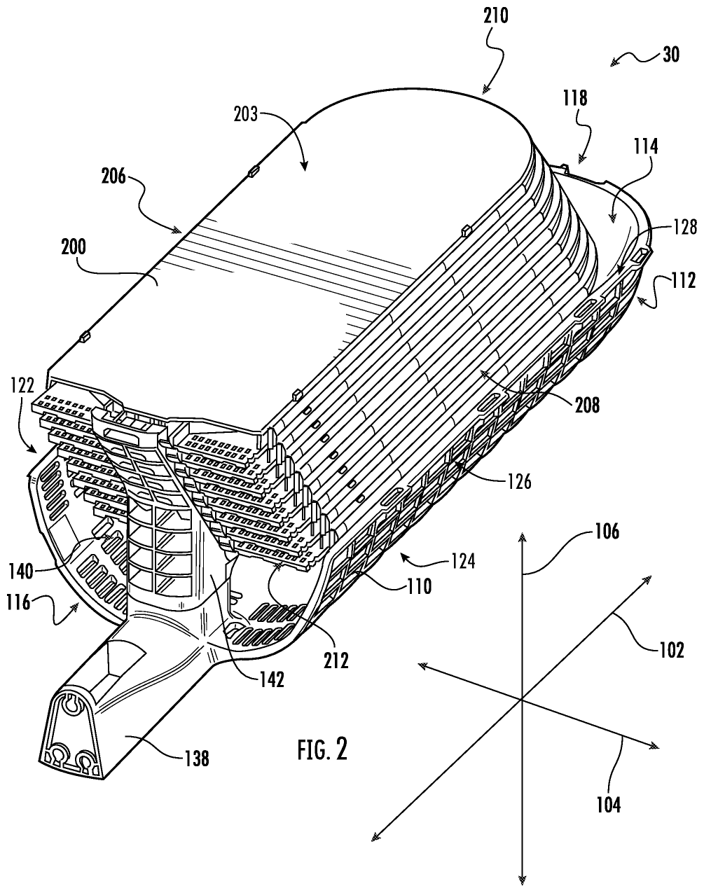

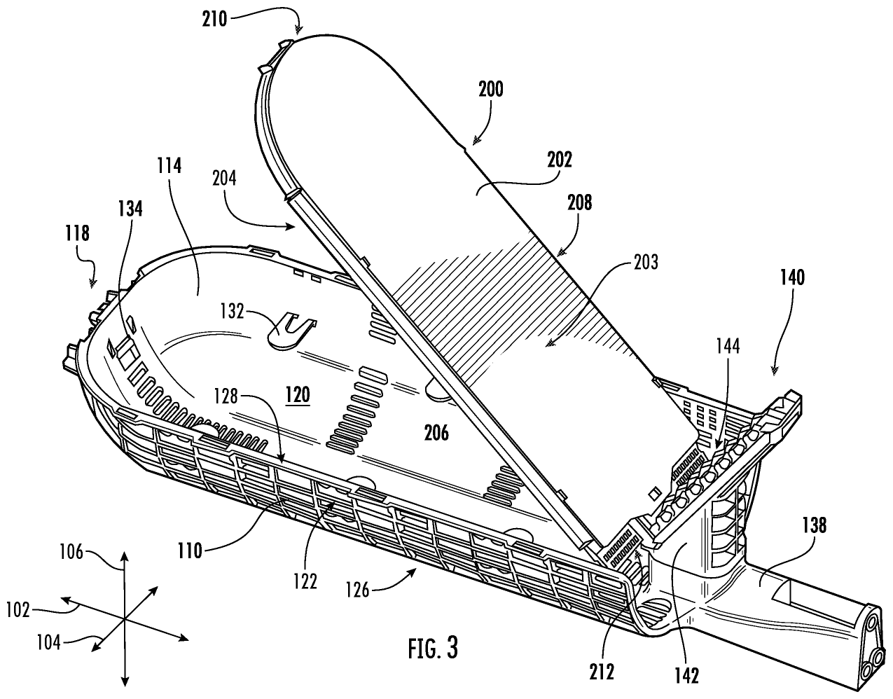

FIGS. 2-3 illustrate various embodiments of an organizer assembly 30 and components thereof in accordance with embodiments of the present disclosure. A mutually orthogonal coordinate system may be defined for organizer assembly 30 in accordance with the present disclosure, and may include a mutually orthogonal longitudinal axis 102, lateral axis 104, and transverse axis 106.

Referring to FIGS. 2-3, organizer assemblies 30 in accordance with the present disclosure may include a basket 110. The basket 110 generally forms at least a portion of the base exterior of the organizer assembly 30, and includes an exterior surface 112 and an interior surface 114. The basket 110 may extend along the longitudinal axis 102 between a first end 116 and a second end 118. The first end 116 may be an open end, as shown, such that cables 42 (FIG. 1) or transmission elements thereof being directed along and parallel to the longitudinal axis 102 can enter or exit an interior 120 of the basket 110 through the first end 116. The second end 118 may be a closed end, as shown, such that cables 42 or transmission elements thereof being directed along and substantially parallel to the longitudinal axis 102 cannot enter an interior 120 of the basket 110 through the second end 118, and instead encounter a surface of the basket 110.

The basket 110 may further extend along the lateral axis 104 between a first side 122 and a second side 124, both of which may be closed (as discussed above with respect to second end 118). In exemplary embodiments, a length between the first end 116 and second end 118 is greater than a length between the first side 122 and the second side 124. Further, in exemplary embodiments, transitions between the closed second end 118 portion and a base portion 126, the closed first side portion 122 and the base portion 126, the closed second side portion 124 and the base portion 126, the closed second end 118 portion and closed first side portion 122, and/or the closed second end 118 portion and closed second side portion 124 are curved.

Basket 110 may generally be utilized to house excess cables 42 and/or transmission elements thereof as the cables 42 and/or transmission elements thereof are routed through the closure 10 and organizer assembly 30 thereof.

Basket 110 may further include an upper peripheral lip 128, which may extend between the first end 116 and second end 118, such as on the sides 122, 124, and may further extend between the sides 122, 124, such as along the closed second end 118. For example, the lip 128 may extend along an upper edge (along the traverse axis 106) of the basket 110, such as along the sides 122, 124 and second end 118.

Referring to FIG. 3, in some embodiments, basket 110 may further include a plurality of basket retainer tabs 132, each of which extends from the basket 110 into the interior 120. The tabs 132 may be connected to the basket 110 at the upper edge of the basket 110, such as adjacent the lip 128. Further, in exemplary embodiments, the tabs 132 are removable. In some embodiments, the tabs 132 may be connected to the basket 110 at interior surface 114 within interior 120. Tabs 132 may generally assist in routing and retaining cables 42 and transmission elements in the interior 120 during assembly, splicing, etc., thereof.

Referring to FIGS. 2-3, a connector shaft 138 may extend from the first end 116 along the longitudinal axis 102, such that at least a portion of the connector shaft 138 is exterior to the basket 110. The connector shaft 138 may connect to the base 40 (FIG. 1), thus connecting the organizer assembly 30 and base 40 together.

A bracket assembly 140 may extend along the transverse axis 106 from the basket 110, such as at the first end 116. Bracket assembly 140 may include a main body 142 and a plurality of hinge assemblies 144. The hinge assemblies 144 may be spaced apart in a linear array along the transverse axis 106. In exemplary embodiments, the hinge assemblies 144 are stepped along the transverse axis 106. In these embodiments, the linear array of the hinge assemblies 144 is angled relative to the transverse axis 106, rather than being directed along or parallel to the transverse axis 106. At least the portion of the main body 142 which includes the hinge assemblies 144 may also be so angled. Such angle may be between the transverse axis 106 and the longitudinal axis 102, as shown.

Organizer assemblies 30 in accordance with the present disclosure may further include one or more organizer trays 200. Each organizer tray 200 is rotatably connectable and removable, and thus may be rotatably connected, to the bracket assembly 140, such as to one of the plurality of hinge assemblies 144. Each organizer tray 200 may be rotatable, such as between a first position in which the organizer tray 200 is aligned along the longitudinal axis 102 (such as shown in FIG. 2) and a second position wherein the organizer tray 200 is aligned along an angle between the transverse axis 106 and the longitudinal axis 102 (such as shown at FIG. 3).

The organizer tray 200 may include a tray main body 202. Tray main body 202 may, for example, include a base wall 204, a first sidewall 206, a second sidewall 208, and a front wall 210, and may further define a rear end 212. First sidewall 206 and second sidewall 208 may be spaced apart along the lateral axis 104. Front wall 210 and rear end 212 may be spaced apart (such as along the longitudinal axis 102 when in the first position). The rear end 212 may be an open end, as shown, such that cables 42 (FIG. 1) or transmission elements thereof being directed along and parallel to the longitudinal axis 102 can enter or exit an interior 214 of the organizer tray 200 through the rear end 212, when the organizer tray 200 is in the first position. The front wall 210 and sidewalls 206, 208 may define a closed end and closed sides. A tray cover 203 (FIGS. 2-3) may be removably positioned to extend over the tray main body 202, such as to provide an enclosure to the interior 214 of the tray 200.

The organizer tray 200 may include a retainer tab 216. Each retainer tab 216 may extend into the interior 214 from a wall, such as sidewalls 206, 208, or front wall 210. Retainer tabs 216 may generally assist in routing and retaining cables (e.g., cable 42) and transmission elements in the interior 214, such as during assembly, splicing, etc.

An opening 218 may be formed through the base wall 204 and corresponding substantially to a location of a respective retainer tab 216. Referring to FIG. 2, in some embodiments, closure 10 may include a plurality of organizer trays 200 stackable atop one another. Opening 218 at a first organizer tray 200 may allow for the tab 216 at an adjacent second organizer tray 200 to position within the opening 218 at the first organizer tray 200. Accordingly, the second organizer tray 200 may stack atop the first organizer tray 200. In still some embodiments, the cover 203 may attach to a top-most organizer tray 200. One or more adjacent organizer trays 200 beneath the top-most organizer tray 200 may include the tab 216 positioning at or aligning to respective opening 218, such as to allow adjacent organizer trays 200 to enclosure or obscure the interior 214 of the organizer tray 200 as provided by the cover 203 at the top-most organizer tray 200.

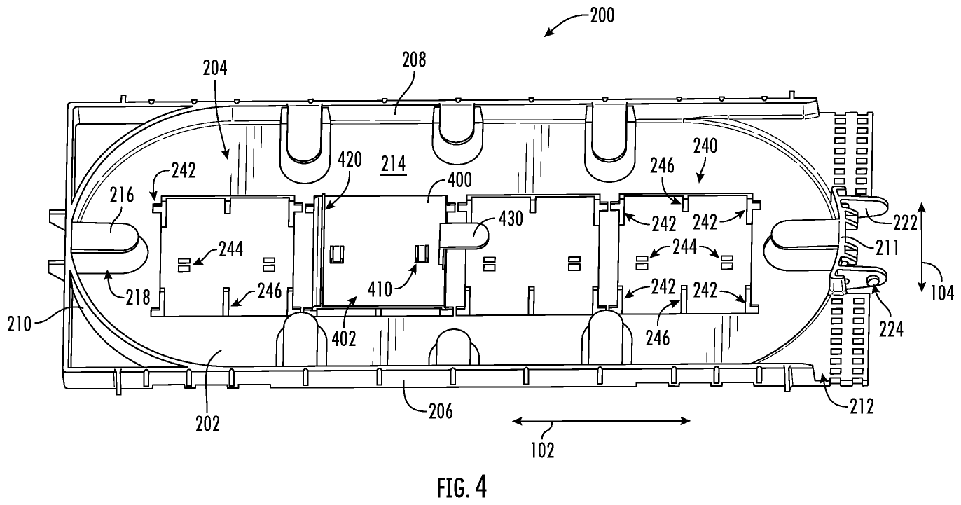

Referring to FIG. 4, the organizer tray 200 may include a hinge 222 extending from the rear end 212 along the longitudinal axis 102. The organizer tray 200 may include a rear wall 211 positioned at the rear end 212 and extending substantially along the lateral axis 104 and the transverse axis 106. The rear wall 211 may extend partially between sidewalls 206, 208, such as to allow rear end 212 to form an open end through which cables 42 and transmission elements may extend into the interior 214 of the organizer tray 200. The hinge 222 may include a member or protrusion 224 configured to extend into the hinge assembly 144 (FIGS. 2-3). The organizer tray 200 may rotatably attach to the bracket assembly 140 via the hinge 222 releasably attachable to the hinge assembly 144.

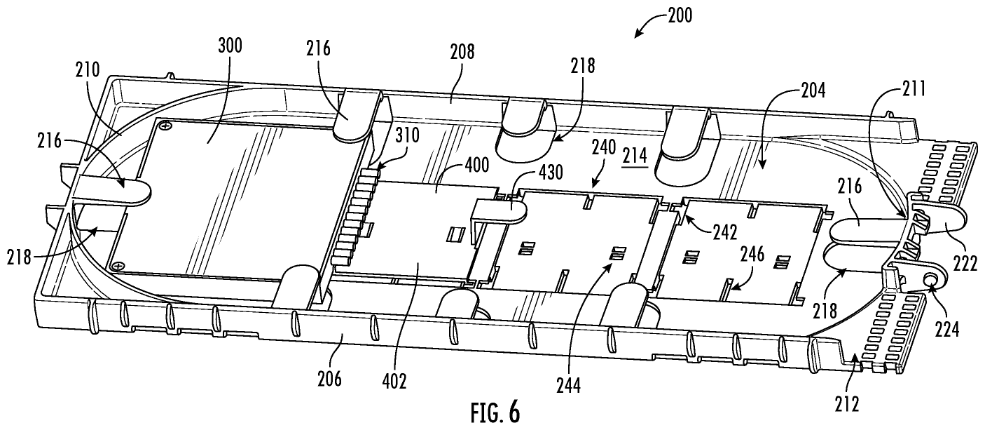

Referring to FIG. 4 and FIG. 6, the base wall 204 may include a plurality of module mounting locations 240. In exemplary embodiments, each of the module mounting locations 240 may include a plurality of leg slots 242 which may be defined through the base wall 204. Each module mounting location 240 may include one or more positioning slots 244 which may be defined through the base wall 204. The leg slot 242 may define at least a portion of a periphery of the module mounting location 240. In some embodiments, the leg slots 242 are disposed at corners of the module mounting location 240. A plurality of positioning slots 244 may be defined within the periphery of the module mounting location 240, and may extend in a linear array. A positioning opening 246 may be defined into the base wall 204 at the mounting location 240. The positioning opening 246 may extend from the periphery of the module mounting location 240 toward an interior area. In some embodiments, the positioning opening 246 may form a slot extending perpendicular or oblique to the positioning slot 244. Accordingly, the positioning slot 244 and the positioning opening 246 may extend through the base wall 204 along directions perpendicular or oblique to one another. The leg slots 242 and positioning slots 244 may generally facilitate removable connection of a mount platform 400 to the organizer tray at the module mounting location 240.

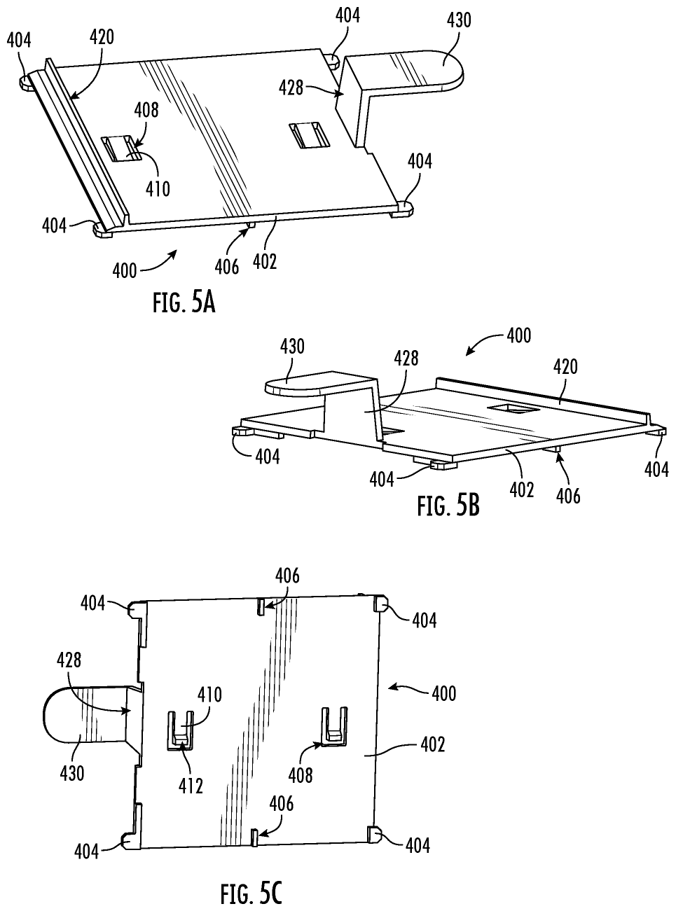

Referring now to FIGS. 4-6, embodiments of a mount platform 400 are provided. FIGS. 5A-5C provide perspective views of embodiments of the mount platform 400. The mount platform 400 may include a base 402 and a leg 404 extending from the base 402. The legs 404 may extend from below the base 402 along the longitudinal axis 102, the lateral axis 104, or both. The base 402 may form a wall or platform configured to form a surface substantially flush to the base wall 204 at the organizer tray 200. The legs 404 may extend from and at least partially form a periphery of the base 402, such as disposed at corners of the base 402. A positioning tab 406 may extend along the transverse axis 106 and correspond to the positioning opening 246 at the organizer tray 200. The positioning tab 406 may be positioned at the base 402 between a pair of legs 404. For instance, the positioning tab 406 may extend from a periphery of the base 402 toward an interior area of the base 402.

Referring to FIGS. 4-6, the mount platform 400 may be removably connectable to the organizer tray 200 at the module mount location 240. Each leg 404 is insertable into corresponding leg slots 244 at the mount location 240. The mount platform 400 may form one or more openings 408 through the base 402. A cantilevered arm 410 extends from the base 402 into the opening 408. Each cantilevered arm 410 may include a tab 412 at a distal end of the cantilevered arm 410. To selectively connect or disconnect the mount platform 400 at the organizer tray 200 at the mount location 240, the cantilevered arm 410, such as the tab 412 thereof, may be inserted into the positioning slot 244 at the module mount location 240.

In exemplary embodiments, the mount platform 400 may be removably connectable to the organizer tray 200 at the module mounting location 240 in multiple different orientations. For instance, the plurality of positioning slots 244 may be oriented such that the cantilevered arm 410, such as the tab 412 thereof, may be inserted in a different one of the plurality of positioning slots 244 depending on the orientation of the mount platform 400.

The mount platform 400 may include a retainer wall 420 extending along the transverse axis 106 from an upper surface of the base 402. The retainer wall 420 may extend along the lateral axis 104, such as to form a detent or perimeter for a telecommunications module 300 mountable to the organizer tray, such as depicted in FIG. 6. The retainer wall 420 at the mount platform 400 may form a removable wall and, along with the front wall 210 at the organizer tray 200, together form a perimeter within the interior 214 of the organizer tray 200 at which the module 300 is positioned and securable along at least the longitudinal axis 102. One or more tabs 216 may extend over the module 300, such as to retain the module 300 along the transverse axis 106. Sidewalls 206, 208, or curvature of the front wall 210 to the sidewalls 206, 208, may retain the module 300 along the lateral axis 104.

In some embodiments, the mount platform 400 further includes a platform retainer tab 430 extending along the longitudinal axis 102, the lateral axis 104, or an oblique direction therebetween. The retainer tab 430 may extend from a wall 428 extending along the transverse axis 106 from the base 402. The retainer tab 430 may be formed similarly as the retainer tab 216 at the organizer tray 200, such as to generally assist in routing and retaining cables (e.g., cable 42) and transmission elements in the interior 214, such as during assembly, splicing, etc.

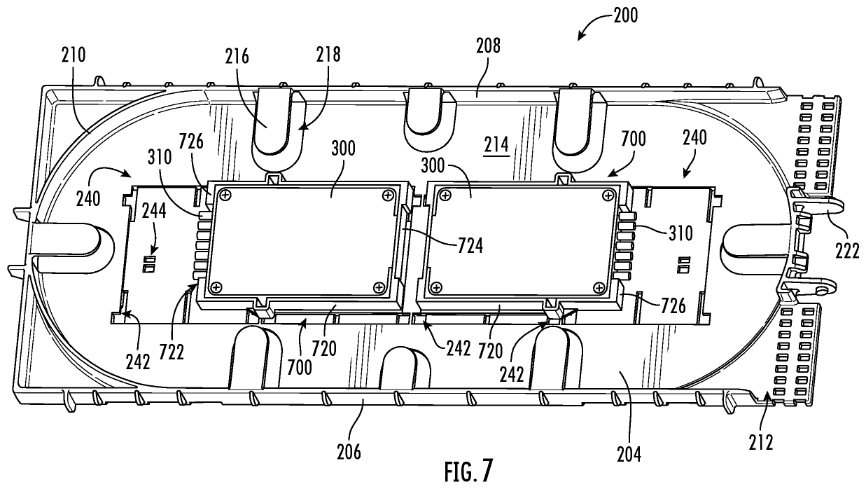

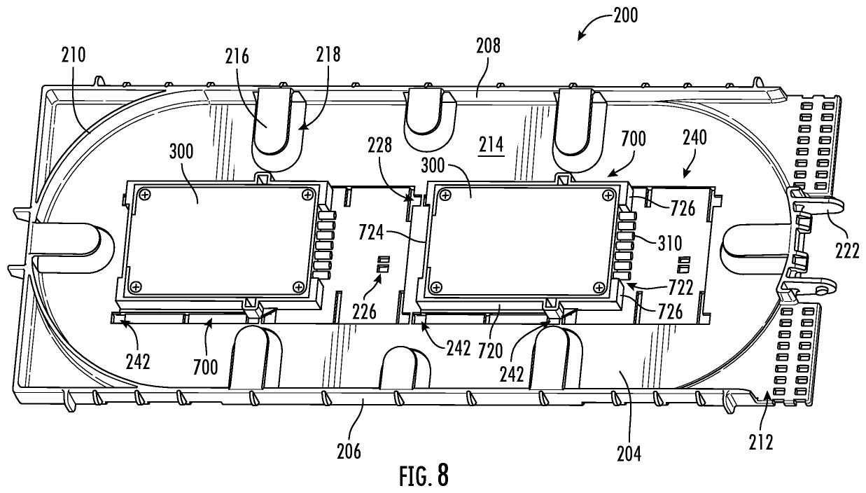

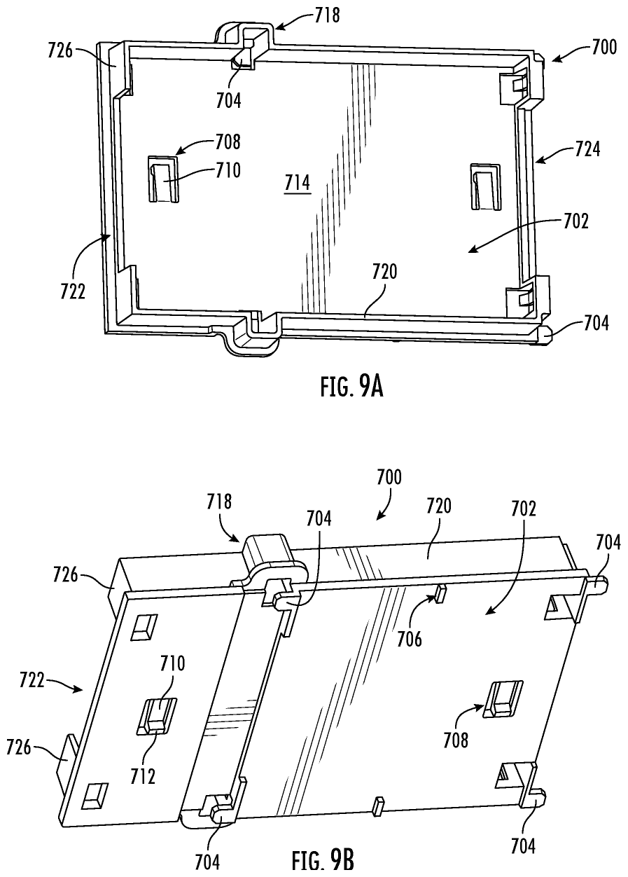

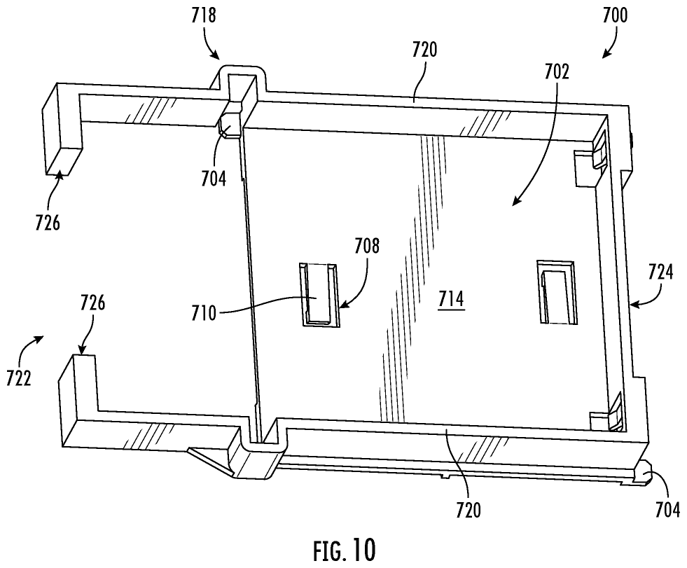

Referring now to FIGS. 7-10, embodiments of a mount platform 700 are provided. FIGS. 7-8 provide perspective views of the mount platform 700 positioned at the module mounting locations 240 in various orientations FIGS. 9A-9B and FIG. 10 provide perspective views of embodiments of the mount platform 700.

The mount platform 700 may include a base 702 and a leg 704 extending from the base 702. The legs 704 may extend from below the base 702 along the longitudinal axis 102, the lateral axis 104, or both. The base 702 may form a wall or platform configured to form a surface substantially flush to the base wall 204 at the organizer tray 200. The legs 704 may extend from and at least partially form a periphery of the base 702, such as disposed at corners of the base 702. A positioning tab 706 may extend along the transverse axis 106 and correspond to the positioning opening 246 at the organizer tray 200. The positioning tab 706 may be positioned at the base 702 between a pair of legs 704. For instance, the positioning tab 706 may extend from a periphery of the base 702 toward an interior area of the base 702.

The mount platform 700 may be removably connectable to the organizer tray 200 at the module mount location 240. Each leg 704 is insertable into corresponding leg slots 244 at the mount location 240. The mount platform 700 may form one or more openings 708 through the base 702. A cantilevered arm 710 extends from the base 702 into the opening 708. Each cantilevered arm 710 may include a tab 712 at a distal end of the cantilevered arm 710. To selectively connect or disconnect the mount platform 700 at the organizer tray 200 at the mount location 240, the cantilevered arm 710, such as the tab 712 thereof, may be inserted into the positioning slot 244 at the module mount location 240.

Referring to FIGS. 9A-9B and FIG. 10, the mount platform 700 includes a retainer wall 720. The retainer wall 720 may form, at least in part, an interior 714 at the mount platform 700. For instance, the retainer wall 720 may extend substantially along a perimeter of the base 702. The retainer wall 720 may be configured to secure or affix the module 300 along a first direction, such as along the lateral axis 104. The mount platform 700 may include a sidewall 724 extending between a pair of retainer walls 720. For instance, the sidewall 724 may extend substantially perpendicular from the retainer wall 720. The sidewall 724, along with the retainer wall 720, may form at least a portion of a peripheral wall or perimeter around the base 702. The sidewall 724 may form an opening 722. The sidewall 724 may include a sidewall segment 726 configured to secure or affix the module 300 along a second direction, such as along the longitudinal axis 102. The opening 722 may form a gap between sidewall segments 726 through which ports 310 (FIGS. 6-8) at the module 300 may extend. For instance, referring to FIGS. 9A-9B, the opening 722 may be formed from the mount platform 700 forming a portion at the sidewall 724 lower than the sidewall segment 726 (e.g., closer to, or flush with, the base 702). In another instance, referring to FIG. 10, the retainer wall 720 may extend beyond the base 702, such that a portion of the interior 714 is unbounded by the base 702. The opening 722 may form an opening between sidewall segments 726. In various embodiments, ports 310, or fibers or other transmission elements coupled thereto, may extend through the opening 722 substantially co-directional to an extension of the retainer wall 720 (e.g., along the longitudinal axis 102 depicted in FIGS. 6-8).

The mount platform 700 may form a passage 718 extending along the transverse axis 106 at the retainer wall 720. The passage 718 may furthermore extend through the base 702 to allow access along the transverse axis 106 to the leg 704. The passage 718 may form a cutaway, opening, or protrusion at the retainer wall 720, such as to remove the retainer wall 720 from obscuring the leg 704 along the transverse axis 106.

In exemplary embodiments, the mount platform 700 may be removably connectable to the organizer tray 200 at the module mounting location 240 in multiple different orientations. For instance, the plurality of positioning slots 244 may be oriented such that the cantilevered arm 710, such as the tab 712 thereof, may be inserted in a different one of the plurality of positioning slots 244 depending on the orientation of the mount platform 700.

FIG. 7 depicts the mount platform 700 positioned such that modules 300 are positioned in directly adjacent positioning slots 244. Ports 310 at a first module 300 extend along the longitudinal axis 102 through the opening 722 toward the front wall 210 and ports 310 at a second module 300 extend along the longitudinal axis 102 through the opening 722 toward the rear end 212.

FIG. 8 depicts the mount platform 700 positioned such that modules 300 are positioned spaced-apart from one another, such that unoccupied positioning slots 244 may be positioned between the modules 300. Ports 310 at each module 300 may extend along the longitudinal axis 102 through the opening 722 toward the open end (e.g., toward the rear end 212).

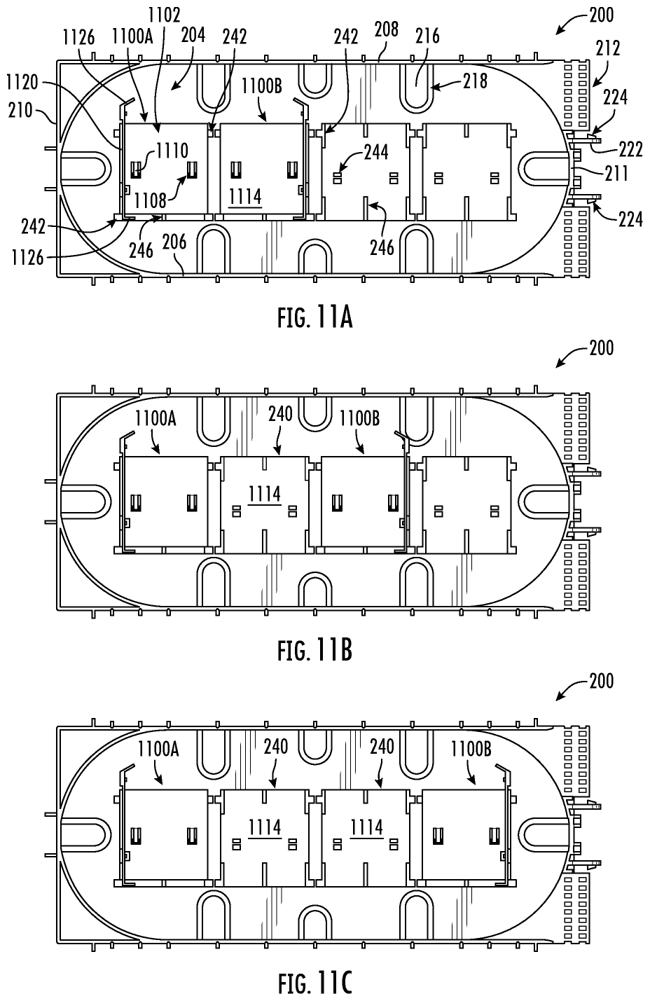

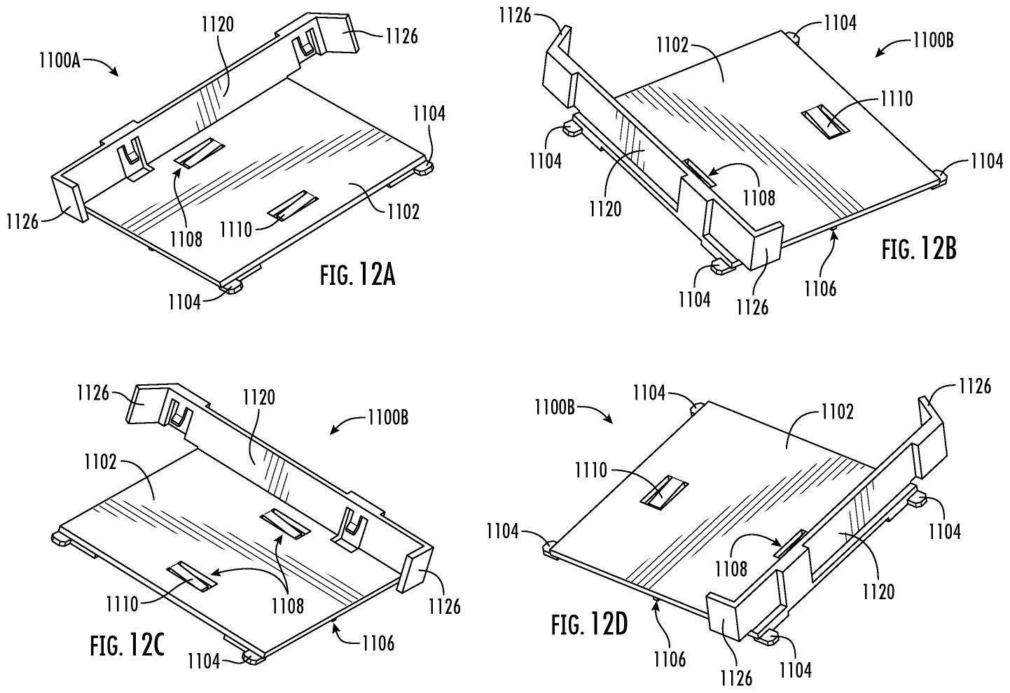

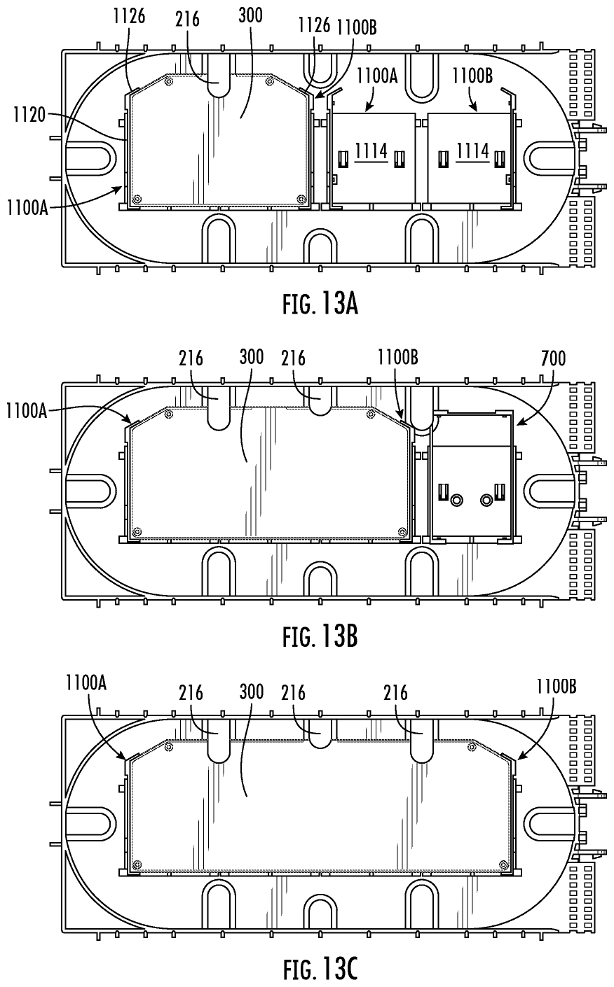

FIGS. 11A-11C provide embodiments of a mount platform 1100A, 1100B at the organizer tray 200. FIGS. 11A-11C provide perspective views of the mount platform 1100 positioned at the module mounting locations 240 in various orientations FIGS. 12A-12D provide perspective views of embodiments of the mount platform 1100A, 1100B. FIGS. 13A-13C provide embodiments of the organizer tray 200 include embodiments of the mount platform and telecommunications module 300. Referring to FIGS. 11A-11C, FIGS. 12A-12B, and FIGS. 13A-13C, the mount platform may include a first mount platform 1100A configured as a first bound along the longitudinal axis 102. Referring to FIGS. 11A-11C, FIGS. 12C-12D, and FIGS. 13A-13C, the mount platform may include a second mount platform 1100B configured as a second bound separated along the longitudinal axis 102 from the first bound.

The mount platform 1100A, 1100B may include a base 1102 and a leg 1104 extending from the base 1102. The legs 1104 may extend from below the base 1102 along the longitudinal axis 102, the lateral axis 104, or both. The base 1102 may form a wall or platform configured to form a surface substantially flush to the base wall 204 at the organizer tray 200. The legs 1104 may extend from and at least partially form a periphery of the base 1102, such as disposed at corners of the base 1102. A positioning tab 1106 may extend along the transverse axis 106 and correspond to the positioning opening 246 at the organizer tray 200. The positioning tab 1106 may be positioned at the base 1102 between a pair of legs 1104. For instance, the positioning tab 1106 may extend from a periphery of the base 1102 toward an interior area of the base 1102.

The mount platform 1100A, 1100B may be removably connectable to the organizer tray 200 at the module mount location 240. Each leg 1104 is insertable into corresponding leg slots 244 at the mount location 240. The mount platform 1100A, 1100B may form one or more openings 1108 through the base 1102. A cantilevered arm 1110 extends from the base 1102 into the opening 1108. Each cantilevered arm 1110 may include a tab at a distal end of the cantilevered arm 1110, such as depicted at mount platform 400, 700. The mount platform 1100A, 1100B may selectively connect or disconnect at the organizer tray 200 at the mount location 240 such as described in regard to mount platform 400, 700.

Referring to FIGS. 12A-12D, the mount platform 1100A, 1100B includes a retainer wall 1120. The retainer wall 720 may extend partially along a perimeter of the base 1102. The retainer wall 1120 may be configured to secure or affix the module 300 (FIGS. 13A-13C) along a first direction, such as along the longitudinal axis 102. The retainer wall 1120 may include a sidewall segment 1126 configured to secure or affix the module 300 along a second direction, such as along the lateral axis 104.

In various embodiments, the mount platform 1100A, 1100B includes the retainer wall 1120 extending substantially along the lateral axis 104, such as to form detents or bounds along the longitudinal axis 102. Sidewall segment 1126 extends at least partially along the longitudinal axis 102 toward the other of the mount platforms 1100A, 1100B. The retainer wall 1120 between the mount platforms 1100A, 1100B may form an interior 1114 at which module 300 is positioned. Referring to FIG. 11A, the interior 1114 may span along the longitudinal axis 102 between an adjacent pair of mount platforms 1100A, 1100B. Referring to FIGS. 11B-11C, the interior 1114 may span along the longitudinal axis 102 between a pair of mount platforms 1100A, 1100B spaced apart from one another along the longitudinal axis 102. For instance, one or more mounting locations 240, such as unoccupied mounting locations, may be positioned between the pair of mount platforms 1100A, 1100B. Referring to FIGS. 13A-13C, a module 300 of corresponding size or geometry may be positioned at the interior 1114.

In exemplary embodiments, the mount platform 700 may be removably connectable to the organizer tray 200 at the module mounting location 240 in multiple different orientations. For instance, the plurality of positioning slots 244 may be oriented such that the cantilevered arm 710, such as the tab 712 thereof, may be inserted in a different one of the plurality of positioning slots 244 depending on the orientation of the mount platform 700.

FIG. 7 depicts the mount platform 700 positioned such that modules 300 are positioned in directly adjacent positioning slots 244. Ports 310 at a first module 300 extend along the longitudinal axis 102 through the opening 722 toward the front wall 210 and ports 310 at a second module 300 extend along the longitudinal axis 102 through the opening 722 toward the rear end 212.

FIG. 8 depicts the mount platform 700 positioned such that modules 300 are positioned spaced-apart from one another, such that unoccupied positioning slots 244 may be positioned between the modules 300. Ports 310 at each module 300 may extend along the longitudinal axis 102 through the opening 722 toward the open end (e.g., toward the rear end 212).

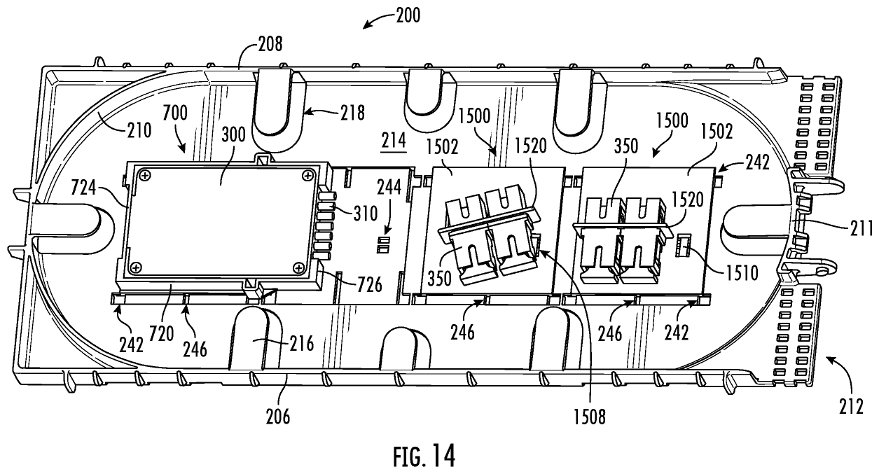

Referring now to FIG. 14, a perspective view of an embodiment of the organizer tray 200 including embodiments of an adapter mount 1500 is provided. Various embodiments of the adapter mount 1500 include a base 1502 and legs 1504, such as described in regard to mount platform 400, 700, 1100. The adapter mount 1500 may further include one or more of a positioning tab 1506, an opening 1508 through which a cantilevered arm 1510 is extended, or both, such as described in regard to mount platform 400, 700, 1100. Embodiments of the adapter mount 1500 are configured to receive and secure an adapter 350 at an adapter wall 1520, such as a fiber optic adapter or coupler.

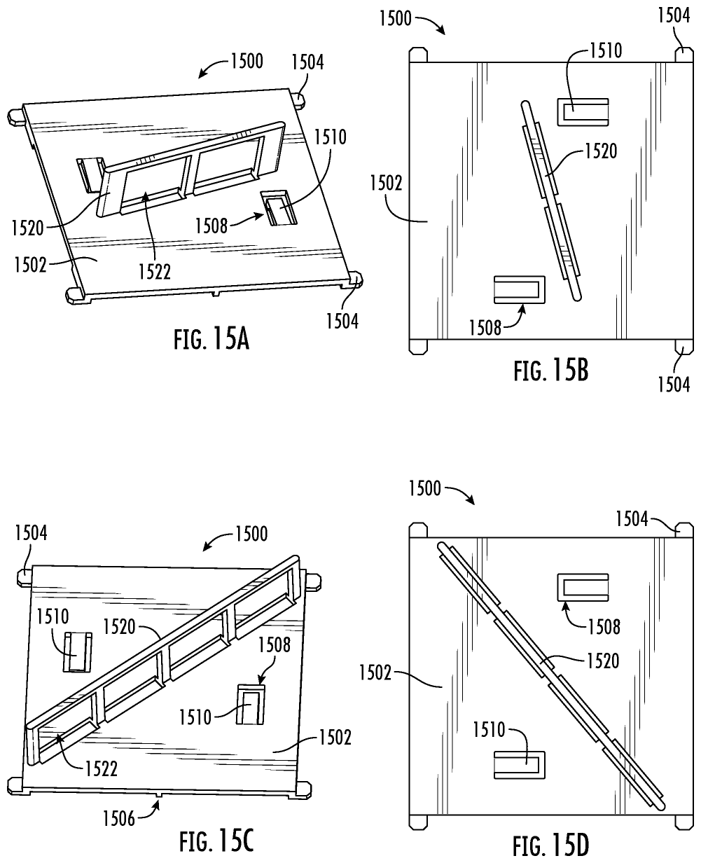

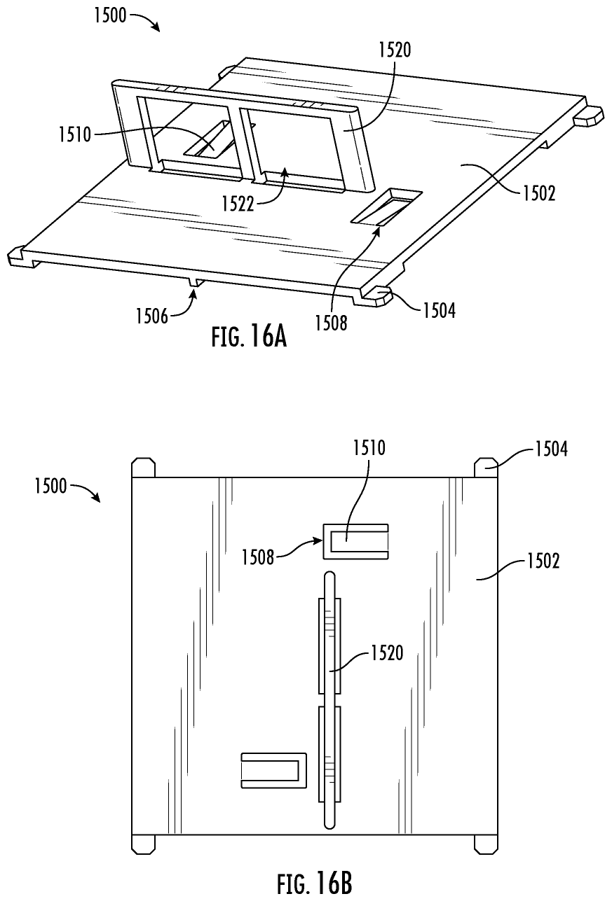

Referring to FIGS. 15A-15D and FIGS. 16A-16B, embodiments of the adapter mount 1500 are provided. In various embodiments, the adapter mount 1500 may include the wall 1520 forming one or more adapter openings 1522 through the wall 1520. The wall 1520 is configured to receive the adapter 350 through the opening 1522. In various embodiments, the wall 1520 is formed integrally to the base 1502. In some embodiments, such as depicted in FIGS. 15A-15D, the wall 1520 extends an angle or diagonally along the base 1502, or oblique relative to the longitudinal axis 102 and the lateral axis 104. In still some embodiments, such as depicted in FIGS. 16A-16B, the wall 1520 extends parallel or perpendicular to the perimeter of the base 1502, or parallel or perpendicular to the longitudinal axis 102 and the lateral axis 104.

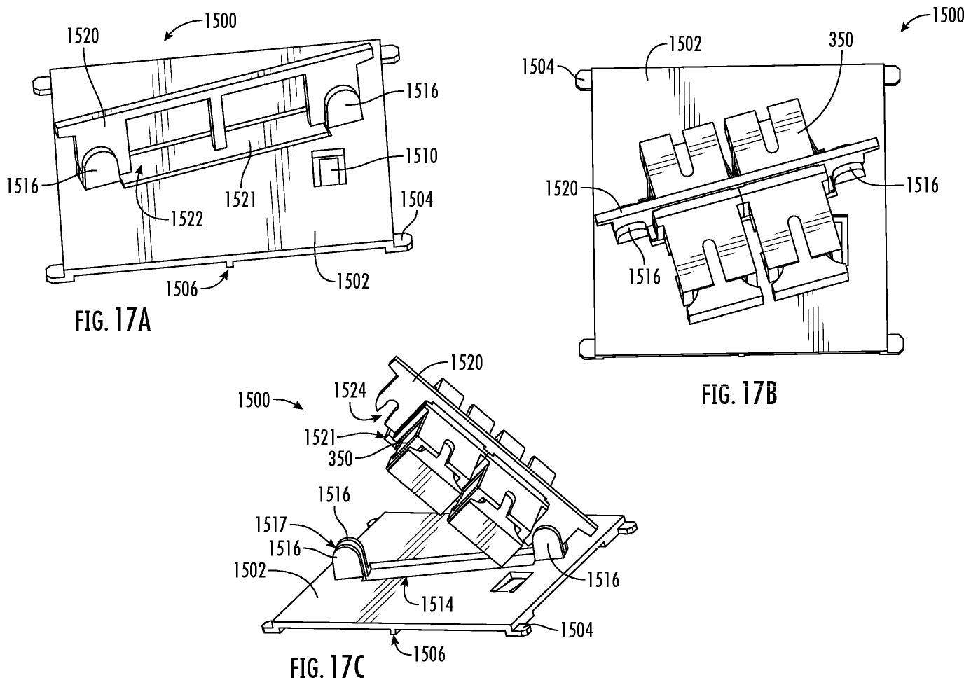

Referring to FIGS. 17A-17C, FIGS. 18A-18D, and FIGS. 19A-19C, embodiments of the adapter mount 1500 are provided. The adapter mount 1500 may include a post 1516 configured to receive the wall 1520. The wall 1520 may be detachable from the base 1502. The wall 1520 may include a notch or opening 1524 configured to receive the post 1516. The wall 1520 may be rotatable up and down relative to the transverse axis 106, or translatable along the transverse axis 106.

For instance, referring to FIGS. 17A-17C, the wall 1520 may be rotatable at the post 1516. The adapter mount 1500 may include two or more of the posts 1516 separated from one another along the longitudinal axis 102 or lateral axis 104. The post 1516, or plurality thereof, may form a channel 1517 at which the wall 1520 is received at the opening 1524.

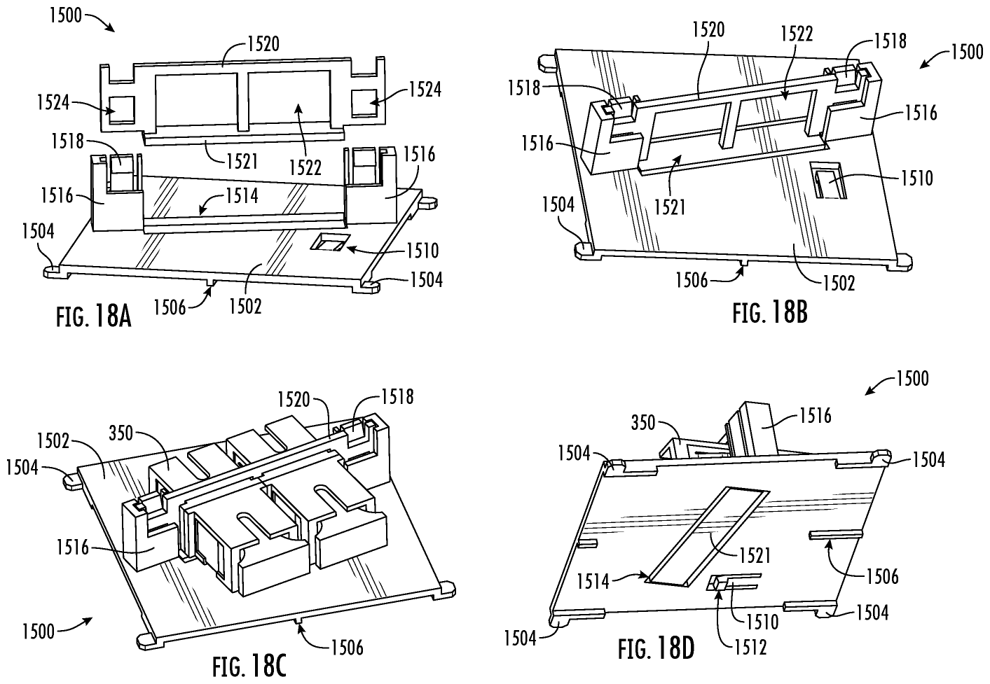

Referring to FIGS. 18A-18D, the wall 1520 may be translatable up and down along the transverse axis 106. The adapter mount 1500 may include the post 1516 and further include a latch 1518 at the post 1516. The latch 1518 is configured to receive the wall 1520 at the opening 1524. The opening 1524 may form a through-hole at which the latch 1518 may attach to the wall 1520.

Referring to FIGS. 17A-17C and FIGS. 18A-18D, the base 1502 may form a slot 1514 configured to receive a base portion 1521 of the wall 1520. The slot 1514 may be configured to extend parallel, perpendicular, or oblique through the base 1502, such as described in regard to the wall 1520. For instance, extension of the slot 1514 through the base 1502 may correspond to extension of wall 1520 relative to the base 1502. Posts 1516 may be positioned at ends of the slot 1514, such as to receive the wall 1520 and position the base portion 1521 into the slot 1514.

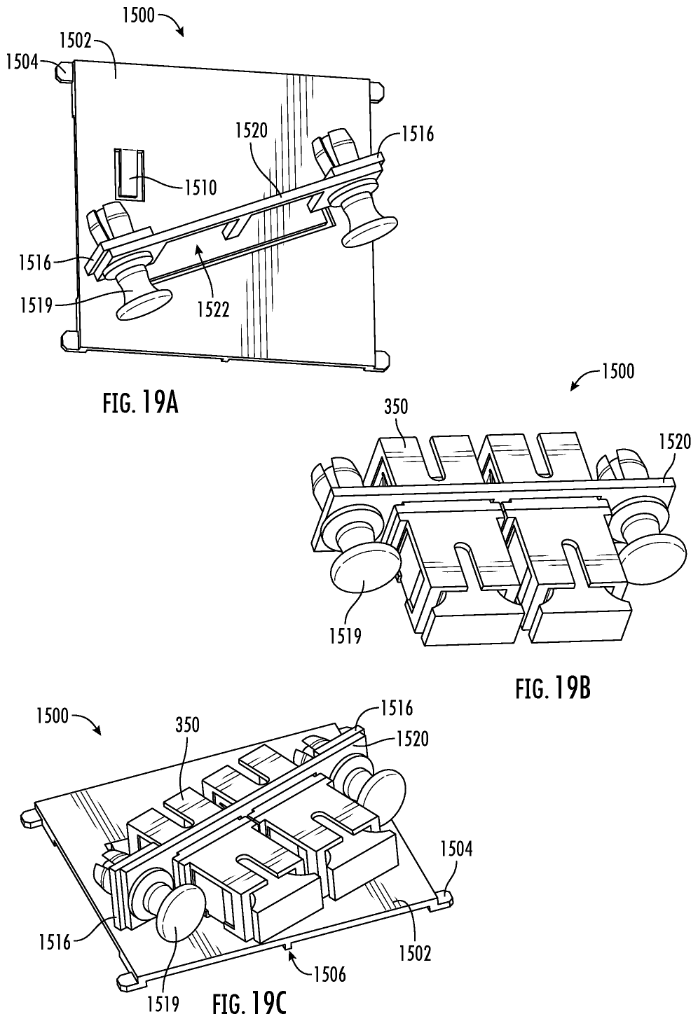

Referring to FIGS. 19A-19C, an embodiment of the adapter mount 1500 is provided. The adapter mount 1500 depicted in FIGS. 19A-19C may be configured such as described in regard to FIGS. 17A-17C and FIGS. 18A-18D. In FIGS. 19A-19C, the post 1516 and the wall 1520 together form a channel extending therethrough to receive a fastener 1519. The fastener 1519 may include rivets, clips, rivet clips, pins, snap locks, screws, tie rods, washers, nut plates, or other appropriate type of fastener, or combinations thereof. The fastener 1519 may affix the wall 1520 to the base 1502 through the post 1516 extending from the base 1502. The post 1516 and the wall 1520 may extend flush to one another.

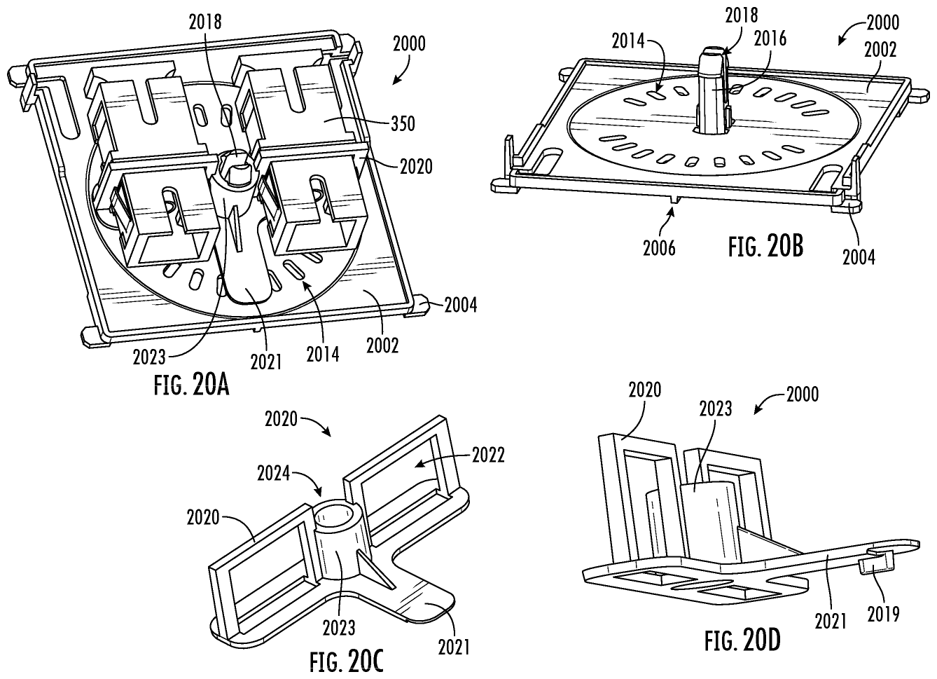

Referring now to FIGS. 20A-20D, an embodiment of an adapter mount 2000 is provided. Various embodiments of the adapter mount 2000 include a base 2002 and legs 2004, such as described in regard to adapter mount 1500. The adapter mount 2000 may further include one or more of a positioning tab 2006, an opening through which a cantilevered arm may be extended, or both, such as described in regard to adapter mount 1500. Embodiments of the adapter mount 2000 are configured to receive and secure the adapter 350 at an adapter wall 2020, such as through one or more adapter openings 2022.

The adapter mount 2000 may include a post 2016 configured to receive the wall 2020. The wall 2020 is detachable from the base 2002 and rotatable around the post 2016. For instance, the post 2016 may extend from a substantially central position from the base 2002. The post 2016 may include a lock or latch 2018 configured to releasably catch onto the wall 2020. For instance, the wall 2020 may include a sleeve 2023 configured to couple around the post 2016. The sleeve 2023 may form a channel 2024 through which the post 2016 is extendable along the transverse axis 106. The sleeve 2023 may be positioned along a central location at the wall 2020. For instance, the sleeve 2023 may be positioned between a pair of adapter openings 2022 formed at the wall 2020 through which the adapter 350 is received.

In various embodiments, the wall 2020 includes a base portion 2021. The base portion 2021 may extend along the base 2002 and include a positioning tab 2019. The positioning tab 2019 may extend along the transverse axis 106 into a slot 2014 formed at the base 2002. The positioning tab 2019 at the wall 2020 may be selectively disposed at one or more of the slots 2014 to orient the wall 2020, the wall opening 2022, and the adapter 350 along a desired angular direction. For instance, referring to FIG. 20B, a plurality of slots 2014 may be formed through the base 2002 in circumferential arrangement around the post 2016. The base portion 2021 extends radially from the sleeve 2023 and the positioning tab 2019 is positioned at a radially distal end of the base portion 2021 (i.e., distal to the sleeve 2023). Selectively disposing the positioning tab 2019 at a desired slot 2014 allows the wall 2020, and accordingly, the opening 2022 and the adapter 350 extended therethrough, to be disposed at one or more angular positions parallel, perpendicular, or oblique to the longitudinal axis 102 and the lateral axis 104.

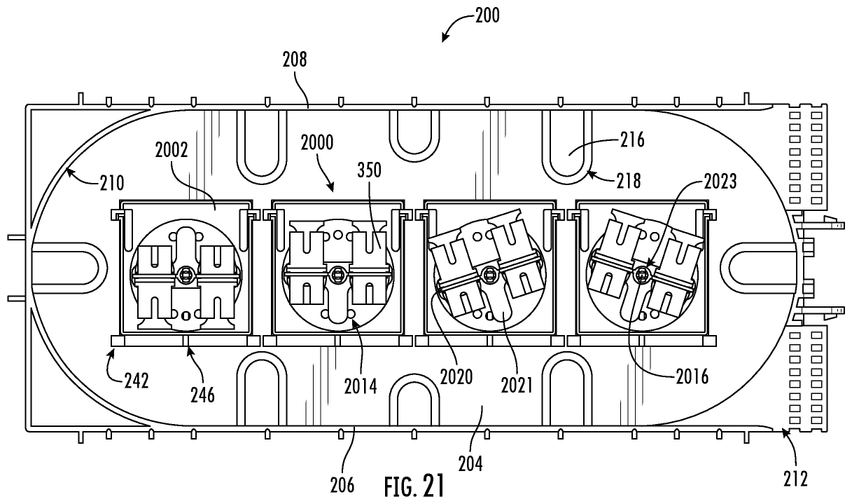

Referring to FIG. 21, a top-down view of the organizer assembly 200 including a plurality of adapter mounts 2000 is provided. The plurality of adapter mounts 2000 are each positioned at different angular positions at which the positioning tab 2019 is placed in a different slot 2014 to dispose the wall 2020 at each angular position. Fixing the adapter mount 2000 at different angular positions allows a user to selectively route cables and transmission elements along the different directions, such as to avoid entanglement and allow for efficient routing.

Embodiments of the closure 10, organizer assembly 30, organizer basket 110, organizer tray 200, mount platform 400, 700, 1100A, 1100B and adapter mount 1500, 2000 provided herein, separately or collectively, may allow users to increase the density of modules 300, adapters 350, cables 42, and transmission and routing elements into a single closure, while permitting maintainability and workability of connections and routing elements within the closure 10, organizer assembly 30, or organizer tray 200. For instance, mount platforms 400, 700, 1100A, 1100B and adapter mounts 1500, 2000 provided herein allow users to affix various desired combinations of telecommunications modules 300 and telecommunications adapters 350 to the organizer tray 200. Further embodiments allow for various desired orientations of the modules 300 and adapters 350, such as to route or desirably bias cables and telecommunications elements toward from an entrance and/or to an exit (e.g., rear end 212). Embodiments provided herein may allow users to more densely pack modules 300, adapters 350, and telecommunications elements at each organizer tray 200, and may further allow for such while maintaining or improving workability (e.g., routing, splicing, etc.) of various telecommunications elements.

Further aspects of the invention are provided by one or more of the following embodiments:

1. A fiber optic closure, the closure including a cover forming a closure interior and an opening providing access to the closure interior; an organizer assembly insertable into the closure interior, the organizer assembly including a bracket assembly extending along a transverse axis, the bracket assembly including a main body and a plurality of hinge assemblies, wherein the plurality of hinge assemblies is spaced apart in a linear array along the transverse axis; one or more organizer trays rotatably connectable and removable to a respective one of the plurality of hinge assemblies at the bracket assembly, the organizer tray including a tray main body, the tray main body including a base wall, a first sidewall, a second sidewall, and a front wall, and a rear end forming an open end and the front wall forming a closed end, wherein the base wall includes a plurality of module mounting locations, the module mounting location including a plurality of leg slots and one or more positioning slots defined through the base wall, wherein the plurality of leg slots form at least a portion of a periphery of the module mounting location; a mount platform including a platform base and a platform leg extending from the platform base, wherein the platform base forms a wall configured substantially flush to the base wall, and wherein the platform leg is insertable into corresponding leg slots at the mount location, the mount platform including a retainer wall extending along the transverse axis from an upper surface of the platform base, wherein the retainer wall extends along a first direction to form a detent for a telecommunications module mountable to the organizer tray, wherein the detent is along a second direction perpendicular to the first direction.

2. The fiber optic closure of any one or more clauses herein, wherein the mount platform is removably mountable to the organizer tray at the platform leg, and wherein the retainer wall at the mount platform forms a removable detent for the telecommunications module.

3. The fiber optic closure of any one or more clauses herein, the one or more organizer trays including a retainer tab extending from the first sidewall, the second sidewall, or the front wall, and wherein the retainer tab forms a detent along the transverse axis to the telecommunications module mountable to the organizer tray.

4. The fiber optic closure of any one or more clauses herein, the mount platform including an opening formed through the platform base, and wherein the platform base includes a cantilevered arm extending into the opening formed through the platform base, wherein the cantilevered arm is configured to insert into the positioning slot at the module mount location to selectively affix the mount platform to the organizer assembly.

5. The fiber optic closure of any one or more clauses herein, wherein the telecommunications module is mountable to the organizer tray between the first side wall, the second side wall, the front wall, and the retainer wall at the mount platform.

6. The fiber optic closure of any one or more clauses herein, wherein the retainer wall extends substantially along a perimeter of the platform base.

7. The fiber optic closure of any one or more clauses herein, wherein the retainer wall is configured to affix the telecommunications module within a platform interior formed by the retainer wall extending substantially along the perimeter of the platform base.

8. The fiber optic closure of any one or more clauses herein, the mount platform including a platform sidewall including a sidewall segment configured to affix the telecommunications module along the second direction.

9. The fiber optic closure of any one or more clauses herein, wherein the platform sidewall forms an opening through which a telecommunications port of the telecommunications module is extendable.

10. The fiber optic closure of any one or more clauses herein, wherein the opening at the platform sidewall is formed between sidewall segments.

11. The fiber optic closure of any one or more clauses herein, wherein the mount platform includes a first mount platform including the retainer wall extending along the perimeter and configured as a first bound along the second direction; and a second platform including the retainer wall extending along the perimeter and configured as a second bound along separated along the second direction from the first bound.

12. The fiber optic closure of any one or more clauses herein, including an adapter mount including a mount base and a mount leg extending from the mount base, wherein the mount base forms a wall configured substantially flush to the base wall, and wherein the mount leg is insertable into corresponding leg slots at the mount location, the adapter mount including a mount wall forming one or more adapter openings configured to receive a telecommunications adapter.

13. The fiber optic closure of any one or more clauses herein, wherein the mount wall is integrally formed to the mount base.

14. The fiber optic closure of any one or more clauses herein, the adapter mount including a post forming a channel at which the mount wall is received at an opening at the mount wall.

15. The fiber optic closure of any one or more clauses herein, the adapter mount including a latch at the post, wherein the latch is configured to receive the mount wall at the opening at the mount wall.

16. The fiber optic closure of any one or more clauses herein, wherein the mount base forms a slot extending through the mount base, wherein extension of the slot corresponds to an orientation of the mount wall parallel, perpendicular, or oblique to a perimeter of the mount base.

17. The fiber optic closure of any one or more clauses herein, the adapter mount including a post extending from a substantially central position from the mount base, wherein the post includes a latch configured to releasably couple to the mount wall, wherein the mount wall includes a sleeve configured to couple around the post.

18. The fiber optic closure of any one or more clauses herein, wherein the mount wall includes a base portion extending along the platform base, and wherein a positioning tab extends from the base portion into a slot formed at the platform base.

19. The fiber optic closure of any one or more clauses herein, wherein the platform base forms a plurality of slots in circumferential arrangement around the post, and wherein the base portion of the mount wall extends radially from the sleeve to dispose the positioning tab at one of the plurality of slots.

20. The fiber optic closure of any one or more clauses herein, wherein selectively disposing the positioning tab at one of the plurality of slots disposes the mount wall at a corresponding angular position parallel, perpendicular, or oblique to a longitudinal axis or lateral axis.

21. A fiber optic closure including a cover, an organizer assembly, a bracket assembly, an organizer tray, and an adapter mount. The cover forms a closure interior and an opening providing access to the closure interior. The organizer assembly is insertable into the closure interior. The organizer assembly includes the bracket assembly extending along a transverse axis. The bracket assembly includes a main body and a plurality of hinge assemblies. The plurality of hinge assemblies is spaced apart in a linear array along the transverse axis. The organizer tray is rotatably connectable and removable to a respective one of the plurality of hinge assemblies at the bracket assembly. The organizer tray includes a tray main body including a base wall, a first sidewall, a second sidewall, and a front wall, and a rear end forming an open end and the front wall forming a closed end. The base wall includes a plurality of module mounting locations including a plurality of leg slots and one or more positioning slots defined through the base wall. The plurality of leg slots form at least a portion of a periphery of the module mounting location. The adapter mount includes a mount base and a mount leg extending from the mount base. The mount base forms a wall configured substantially flush to the base wall. The mount leg is insertable into corresponding leg slots at the mount location. The adapter mount includes a mount wall forming one or more adapter openings configured to receive a telecommunications adapter.

22. An organizer tray, the organizer tray including a tray main body, the tray main body including a base wall, a first sidewall, a second sidewall, and a front wall, and a rear end forming an open end and the front wall forming a closed end, wherein the base wall includes a plurality of module mounting locations, the module mounting location including a plurality of leg slots and one or more positioning slots defined through the base wall, wherein the plurality of leg slots form at least a portion of a periphery of the module mounting location; and a mount platform including a platform base and a platform leg extending from the platform base, wherein the platform base forms a wall configured substantially flush to the base wall, and wherein the platform leg is insertable into corresponding leg slots at the mount location, the mount platform including a retainer wall extending along the transverse axis from an upper surface of the platform base, wherein the retainer wall extends along a first direction to form a detent for a telecommunications module mountable to the organizer tray, wherein the detent is along a second direction perpendicular to the first direction.

23. An organizer tray, the organizer tray including a tray main body, the tray main body including a base wall, a first sidewall, a second sidewall, and a front wall, and a rear end forming an open end and the front wall forming a closed end, wherein the base wall includes a plurality of module mounting locations, the module mounting location including a plurality of leg slots and one or more positioning slots defined through the base wall, wherein the plurality of leg slots form at least a portion of a periphery of the module mounting location; and an adapter mount including a mount base and a mount leg extending from the mount base, the mount base forming a wall configured substantially flush to the base wall, the mount leg insertable into corresponding leg slots at the mount location, the adapter mount including a mount wall forming one or more adapter openings configured to receive a telecommunications adapter.

24. The organizer tray of any one or more clauses herein, including the mount platform and the adapter mount of any one or more clauses herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A fiber optic closure, the closure comprising:
a cover forming a closure interior and an opening providing access to the closure interior;
an organizer assembly insertable into the closure interior, the organizer assembly comprising:
a bracket assembly extending along a transverse axis, the bracket assembly comprising a main body and a plurality of hinge assemblies, wherein the plurality of hinge assemblies is spaced apart in a linear array along the transverse axis;
one or more organizer trays rotatably connectable and removable to a respective one of the plurality of hinge assemblies at the bracket assembly, the organizer tray comprising a tray main body, the tray main body comprising a base wall, a first sidewall, a second sidewall, and a front wall, and a rear end forming an open end and the front wall forming a closed end, wherein the base wall comprises a plurality of module mounting locations, the module mounting location comprising a plurality of leg slots and one or more positioning slots defined through the base wall, wherein the plurality of leg slots form at least a portion of a periphery of the module mounting location;
a mount platform comprising a platform base and a platform leg extending from the platform base, wherein the platform base forms a wall configured substantially flush to the base wall, and wherein the platform leg is insertable into corresponding leg slots at the mount location, the mount platform comprising a retainer wall extending along the transverse axis from an upper surface of the platform base, wherein the retainer wall extends along a first direction to form a detent for a telecommunications module mountable to the organizer tray, wherein the detent is along a second direction perpendicular to the first direction.

2. The fiber optic closure of claim 1, wherein the mount platform is removably mountable to the organizer tray at the platform leg, and wherein the retainer wall at the mount platform forms a removable detent for the telecommunications module.

3. The fiber optic closure of claim 2, the one or more organizer trays comprising a retainer tab extending from the first sidewall, the second sidewall, or the front wall, and wherein the retainer tab forms a detent along the transverse axis to the telecommunications module mountable to the organizer tray.

4. The fiber optic closure of claim 1, the mount platform comprising:
an opening formed through the platform base, and wherein the platform base comprises a cantilevered arm extending into the opening formed through the platform base, wherein the cantilevered arm is configured to insert into the positioning slot at the module mount location to selectively affix the mount platform to the organizer assembly.

5. The fiber optic closure of claim 1, wherein the telecommunications module is mountable to the organizer tray between the first side wall, the second side wall, the front wall, and the retainer wall at the mount platform.

6. The fiber optic closure of claim 1, wherein the retainer wall extends substantially along a perimeter of the platform base.

7. The fiber optic closure of claim 6, wherein the retainer wall is configured to affix the telecommunications module within a platform interior formed by the retainer wall extending substantially along the perimeter of the platform base.

8. The fiber optic closure of claim 6, the mount platform comprising:
a platform sidewall comprising a sidewall segment configured to affix the telecommunications module along the second direction.

9. The fiber optic closure of claim 8, wherein the platform sidewall forms an opening through which a telecommunications port of the telecommunications module is extendable.

10. The fiber optic closure of claim 9, wherein the opening at the platform sidewall is formed between sidewall segments.

11. The fiber optic closure of claim 1, wherein the mount platform comprises:
a first mount platform comprising the retainer wall extending along the perimeter and configured as a first bound along the second direction; and
a second platform comprising the retainer wall extending along the perimeter and configured as a second bound along separated along the second direction from the first bound.

12. The fiber optic closure of claim 11, comprising:
an adapter mount comprising a mount base and a mount leg extending from the mount base, wherein the mount base forms a wall configured substantially flush to the base wall, and wherein the mount leg is insertable into corresponding leg slots at the mount location, the adapter mount comprising a mount wall forming one or more adapter openings configured to receive a telecommunications adapter.

13. The fiber optic closure of claim 12, wherein the mount wall is integrally formed to the mount base.

14. The fiber optic closure of claim 12, the adapter mount comprising a post forming a channel at which the mount wall is received at an opening at the mount wall.

15. The fiber optic closure of claim 14, the adapter mount comprising a latch at the post, wherein the latch is configured to receive the mount wall at the opening at the mount wall.

16. The fiber optic closure of claim 12, wherein the mount base forms a slot extending through the mount base, wherein extension of the slot corresponds to an orientation of the mount wall parallel, perpendicular, or oblique to a perimeter of the mount base.

17. The fiber optic closure of claim 12, the adapter mount comprising a post extending from a substantially central position from the mount base, wherein the post comprises a latch configured to releasably couple to the mount wall, wherein the mount wall comprises a sleeve configured to couple around the post.

18. The fiber optic closure of claim 17, wherein the mount wall comprises a base portion extending along the platform base, and wherein a positioning tab extends from the base portion into a slot formed at the platform base.

19. The fiber optic closure of claim 18, wherein the platform base forms a plurality of slots in circumferential arrangement around the post, and wherein the base portion of the mount wall extends radially from the sleeve to dispose the positioning tab at one of the plurality of slots.

20. The fiber optic closure of claim 19, wherein selectively disposing the positioning tab at one of the plurality of slots disposes the mount wall at a corresponding angular position parallel, perpendicular, or oblique to a longitudinal axis or lateral axis.
